(19) United States
(12) Patent Application Publication
(10) Pub. No.: US 2021/0114407 A1
(43) Pub. Date: Apr. 22, 2021

(54) A ROLLING ASSEMBLY

(71) Applicant: Compagnie Generale Des Etablissements Michelin, Clermont-Ferrand (FR)

(72) Inventor: Kenji FUKUDA, Tokyo (JP)

(21) Appl. No.: 17/041,706

(22) PCT Filed: Mar. 30, 2018
(86) PCT No.: PCT/JP2018/013618

§ 371 Date: Sep. 25, 2020

(51) Int. Cl. B60B 21/12; B60C 15/02

(52) U.S. Cl. CPC B60B 21/12; B60B 21/10; B60C 15/0223

(57) ABSTRACT

The rolling assembly has a rotation axis and comprises a rim having two rim seats that is axially outwardly extended by rim flanges, one adapter and a tire having two beads. The adapter provides the connection between one of the beads and the rim and comprises an axially inner end that is adapted to be mounted on one of the rim seats, an axially outer end that is adapted to receive one of the beads and an adapter body connecting the axially inner end and the axially outer end as to form a single piece. The two rim seats of the rim have different diameters with a gap D. The adapter is mounted onto the rim seat having smaller diameter. The rim seat of the rim has a smaller diameter positions on a side intended to be inside when the rolling assembly being mounted onto a vehicle.

### CROSS-REFERENCE TO RELATED APPLICATIONS

This application claims priority to and the benefit of PCT Patent Application No. PCT/JP2018/013618, filed Mar. 30, 2018, entitled “A ROLLING ASSEMBLY.”

### BACKGROUND OF THE INVENTION

### 1. Technical Field

The present invention relates to a rim for a vehicle including a seat for receiving a tire bead is radially floating. The invention relates in particular systems containing flexible adapter inserted between a tire bead and a rim.

A tire, a rim, an adapter, referred to in the present invention, objects are usually described by a representation in a meridian plane, that is to say a plane containing a rotation axis (an axis of rotation) of the tire. All these products (a tire, a rim and an adapter) are objects having geometry of revolution relative to their axis of rotation.

### 2. Related Art

A tire currently used these days mainly comprises a tread intended to provide contact with ground, this tread generally being reinforced by a crown reinforcement which is positioned radially inward of the tread. The crown reinforcement is able to give the crown the rigidities, in the three dimensions, which needs for the running of the tire. The crown reinforcement also limits the radial expansion of a carcass reinforcement, generally made up of one or more plies of radial reinforcing elements. When the tire is mounted so as to become functional, it contains an inflation gas, inflated to a nominal pressure. The carcass reinforcement, during the use of the tire within reasonable limits, deforms both statically and when running. The carcass reinforcement is generally anchored in each bead to a reinforcing ring. The beads provide contact with the seat and flange of the rim on which the tire is mounted.

Transmission of mechanical load between the tire and the rim, which load is the result of the inflation, compression and running of the tire, and sealing of this tire are provided by the distribution and the magnitude of the forces of contact between the bead and the rim seats and rim flanges. Good tire behavior both from the standpoint of endurance and from the standpoint of the properties conferred on the vehicle equipped with it, and a good mounting rim quality/price ratio have led to the adoption of a ratio of rim width to maximum axial tire width of around 0.7. It is known that this ratio is merely a compromise and that a certain number of tire properties, for example road holding are improved by the use of a rim allowing a higher ratio; conversely, other properties can be improved, of course at the expense of the former properties, by mounting on a narrow rim, namely by having a ratio, as defined hereinabove, of around 0.40 or less.

WO00/078565 discloses a rolling assembly having an elastic adapter inserted between a rim and beads of a tire. This adapter is elastically deformable in the radial and in axial directions. Such an adapter makes it possible to separate that part of the rolling assembly that can be considered to actually act as a tire from that part of the rolling assembly that can be considered to act as a rim.

WO2015/091620 discloses an adapter for a rolling assembly comprising a tire and a rim, the adapter providing a connection between the rim and a bead of the tire, the adapter comprising an axially inner end comprising an inner reinforcer element, an axially outer end comprising an outer reinforcer element, a body connecting the outer end and the inner end as to form a single piece and comprising at least one main reinforcement for reducing level of mechanical forces towards chassis in an event of an impact while maintaining a very good ability to withstand curb impact.

These solutions improve interior noise performance by shifting tire vibration mode frequency lower. However with these solutions steering improvement is not yet satisfactory while maintaining, even improving interior noise performance and/or ability to withstand curb impact.

WO94/013498 discloses a rim for mounting a tire having different seat diameters for improving condition of operation in case of travel in degraded manner with zero or low pressure to be used with or without tread support.

### CITATION LIST

### Patent Literature

### PTL 1: WO0/078565

### PTL 2: WO2015/091620

### PTL 3: WO94/013498

Therefore, there is a need for a rolling assembly which improves steering of a vehicle simultaneously with satisfactory interior noise performance and/or ability to withstand curb impact.

### Definitions

A “radial direction/orientation” is a direction/orientation perpendicular to axis of rotation of the tire. This direction/orientation corresponds to thickness orientation of the tread.

An “axial direction/orientation” is a direction/orientation parallel to axis of rotation of the tire.

A “circumferential direction/orientation” is a direction/orientation which is tangential to any circle centered on axis of rotation. This direction/orientation is perpendicular to both the axial direction/orientation and the radial direction/orientation.

An “equatorial plane” is a plane perpendicular to the axis of rotation and passing through middle of a tread.

An “inflation state” is a state in which a rolling assembly is inflated to its nominal pressure corresponding to a tire dimension in the rolling assembly as defined in tire standards such as ETRTO, JATMA or TRA.

It is thus an object of the invention to provide a rolling assembly comprising a tire, a rim and one adapter, such the rolling assembly can provide improvement on steering of a vehicle simultaneously with satisfactory interior noise performance and/or ability to withstand curb impact.

### SUMMARY OF THE INVENTION

The present invention provides a rolling assembly having a rotation axis and comprising a rim having two rim seats being axially outwardly extended by rim flanges, one adapter and a tire having two beads, the adapter providing the connection between one of the beads and the rim, the adapter comprising an axially inner end that is adapted to be mounted on one of the rim seats, an axially outer end that is adapted to receive one of the beads and an adapter body connecting the axially inner end and the axially outer end as to form a single piece, the two rim seats of the rim having different diameter with a gap D, the adapter being mounted onto the rim seat having smaller diameter, the rim seat of the rim having smaller diameter positions on a side intended to be inside when the rolling assembly being mounted onto a vehicle.

This arrangement provides improvement on steering of a vehicle while maintaining satisfactory interior noise performance and/or ability to withstand curb impact.

Since the adapter providing the connection between one of the beads and the rim, the adapter can deform at least in radial and in axial directions, thus it is possible to improve comfort and ability to withstand curb impact. The adapter also makes it possible to improve interior noise performance by shifting vibration mode frequency lower.

Since the rolling assembly comprises one adapter and the two rim seats of the rim having different diameter with a gap D and the adapter being mounted onto the rim seat having smaller diameter, the rolling assembly accepts to use conventional pneumatic or non-pneumatic tire with the rim and the adapter while keeping assembling difficulty similar to that of without adapter. This combination also makes it possible to reduce number of parts within the rolling assembly.

Since the rim seat of the rim having smaller diameter positions on a side intended to be inside when the rolling assembly being mounted onto a vehicle, it is possible to improve steering of a vehicle as outside bead of the tire is directly mounted onto the rim seat of the rim which has no or extremely small deformation compare to the adapter.

In another preferred embodiment, the gap D is at least equal to 0.25 inches.

If this gap D is less than 0.25 inches, assembling difficulty of the rolling assembly becomes extremely difficult, almost impossible to assemble the rolling assembly. By setting this gap D at least equal to 0.25 inches, it is possible to maintain assembling difficulty of the rolling assembly similar to that of without the adapter. The gap D is preferably at least equal to 0.5 inches, more preferably at least equal to 0.5 inches and at most equal to 2.0 inches, and still more preferably at least equal to 0.75 inches and at most equal to 1.5 inches.

In another preferred embodiment, an axial width of the adapter is wider than an axial width of the rim at inflation state.

According to this arrangement, it is possible to improve further comfort, ability to withstand curb impact and interior noise performance.

In another preferred embodiment, an axial width of the rim is wider than an axial width of the adapter at inflation state.

According to this arrangement, it is possible to improve further steering of a vehicle by limiting deformable length created by the adapter.

### Advantageous Effects of the Invention

According to the arrangements described above, it is possible to provide improvement on steering of a vehicle while maintaining satisfactory interior noise performance and/or ability to withstand curb impact.

### BRIEF DESCRIPTION OF THE DRAWINGS

Other characteristics and advantages of the invention arise from the description made hereafter in reference to the annexed drawings which show, as nonrestrictive examples, the embodiment of the invention.

In these drawings:

FIG. 1 is a schematic sectional view of a rolling assembly according to a first embodiment of the present invention;

FIG. 2 is a schematic sectional view of a rim of the rolling assembly according to the first embodiment of the present invention;

FIG. 3 is a schematic sectional view of a rolling assembly according to a second embodiment of the present invention;

### DETAILED DESCRIPTION OF THE ENABLING EMBODIMENTS

Preferred embodiments of the present invention will be described below referring to the drawings.

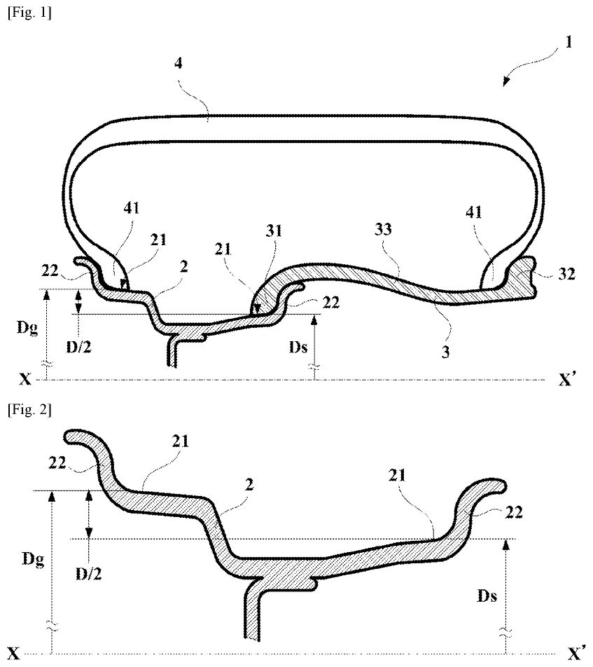

A rolling assembly 1 according to a first embodiment of the present invention will be described referring to FIGS. 1 and 2.

FIG. 1 is a schematic sectional view of a rolling assembly according to a first embodiment of the present invention. FIG. 2 is a schematic sectional view of a rim of the rolling assembly according to the first embodiment of the present invention.

The rolling assembly 1 is a rolling assembly having a rotation axis XX′ where X is a direction intended to be outside when the rolling assembly 1 being mounted onto a vehicle, thus X′ is a direction intended to be inside when the rolling assembly 1 being mounted onto a vehicle, and comprising a rim 2 having two rim seats 21 being axially outwardly extended by rim flanges 22, one adapter 3 and a tire 4 having two beads 41, the adapter 3 providing the connection between one of the bead 41 and the rim 2. In this FIG. 1, the rolling assembly 1 is in an inflation state.

The adapter 3 comprising an axially inner end 31 that is adapted to be mounted on one of the rim seats 21, an axially outer end 32 that is adapted to receive one of the beads 41 and an adapter body 33 connecting the axially inner end 31 and the axially outer end 32 as to form a single piece.

As shown in FIG. 2, The two rim seats 21 of the rim 2 having different diameter, smaller diameter Ds and greater diameter Dg with a gap D (indicated as D/2 as FIG. 1 shows half of the rolling assembly 1), the adapter 3 being mounted onto the rim seat 21 having smaller diameter Ds. The rim seat 21 of the rim 2 having smaller diameter Ds positions on a side intended to be inside when the rolling assembly 1 being mounted onto a vehicle.

The gap D is at least equal to 0.25 inches. In this embodiment, this gap D is equal to 0.50 inches.

An axial width of the adapter 3 is wider than an axial width of the rim 2 at inflation state.

Since the adapter 3 providing the connection between one of the beads 41 and the rim 2, the adapter 3 can deform at least in radial and in axial directions, thus it is possible to improve comfort and ability to withstand curb impact. The adapter 3 also makes it possible to improve interior noise performance by shifting vibration mode frequency lower.

Since the rolling assembly 1 comprises one adapter 3 and the two rim seats 21 of the rim 2 having different diameter with a gap D and the adapter 3 being mounted onto the rim seat 21 having smaller diameter, the rolling assembly 1 accepts to use conventional pneumatic or non-pneumatic tire 4 with the rim 2 and the adapter 3 while keeping assembling difficulty similar to that of without adapter 3. This combination also makes it possible to reduce number of parts within the rolling assembly 1.

Since the rim seat 21 of the rim 2 having smaller diameter Ds positions on a side intended to be inside when the rolling assembly 1 being mounted onto a vehicle, it is possible to improve steering of a vehicle as outside bead 41 of the tire 4 which is important for transmitting a load during cornering is directly mounted onto the rim seat 21 of the rim 2 which has no or extremely small deformation compare to the adapter 3.

The rim 2 is preferably made of a material selected from steel or alloys of aluminum and/or magnesium, composite materials based on carbon fiber, glass fiber, aramid fiber, plant fiber, the said fibers being contained within a matrix based on thermosetting or thermoplastic compounds, or from a complex composite comprising an elastomer and a complex based on resin and fibers selected from carbon fibers, glass fibers, aramid fibers, plant fibers or any combinations of materials.

The matrix based on thermosetting compounds is selected from epoxy resins, vinylester, unsaturated polyesters, ester cyanate, bismaleimide, acrylic resins, phenolic resins, polyurethanes and combinations thereof.

The matrix based on thermoplastic compounds is selected from polypropylene (PP), polyethylene (PE), polyamides (PA), semiaromatic polyamides, polyester (PET), polybutylene terephthalate (PBT), polyetheretherketone (PEEK), polyetherketoneketone (PEKK), polyethersulphone (PSU), polyetherimide (PEI), polyimide (P1), polyamidelmide (PAl), polyphenylenesulphide (PPS), polyoxymethylene (POM), polyphenylene oxide (PPO).

The adapter 3 may be any kind being elastically deformable in the two, radial and axial, directions known to those skilled in the art. The adapter 3 may include an adapter bead (not shown) in the inner end 31 of the adapter 3 intended to catch the adapter 3 on top of the rim flange 22 of the rim 2, as being done conventionally by the bead 41 of the tire 4. The outer end 32 of the adapter 3 which accepts the bead 41 of the tire 4 in exactly the same way as the top of the rim flange 22 of the rim 2 conventionally does. The outer end 32 of the adapter 3 may also include an adapter bead (not shown), which may be the same or different with the adapter bead included in the inner end 31 of the adapter 3.

The adapter 3 may be made of elastomers such as rubbers that can be crosslinked by chemical vulcanization reactions by sulfurbridges, by carbon-carbon bonds created by the action of peroxides or of ionizing radiation, by other specific atom chains of the elastomer module, thermoplastic elastomers (TPEs) in which the elastically deformable part forms a network between rather non-deformable “hard” regions, the cohesion of which is the product of physical connections (crystallites or amorphous regions above their glass transition temperature), non-thermoplastic elastomers and thermoset resins. The adapter 3 may also include a plurality of reinforcement along the inner end 31, adapter body 33 and the outer end 32, which may be made of metal (for example steel) cords or textile cords (for example rayon, aramid, polyethylene, nylon, glass fiber, carbon fiber, basalt fiber, PEN or PVA).

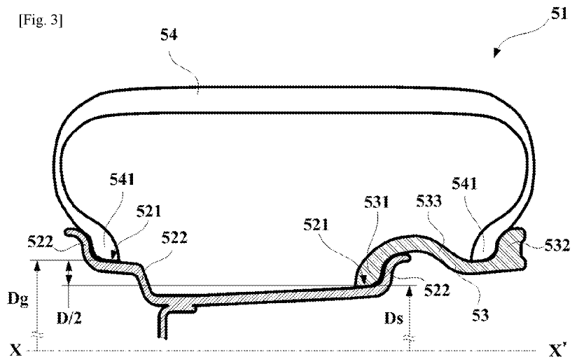

A rolling assembly 51 according to a second embodiment of the present invention will be described referring to FIG. 3. FIG. 3 is a schematic sectional view of a rolling assembly according to a second embodiment of the present invention. The construction of this second embodiment is similar to that of the first embodiment other than the arrangement shown in FIG. 3, thus description will be made referring to FIG. 3.

As shown in FIG. 3, the rolling assembly 51 is a rolling assembly having a rotation axis XX′ where X is a direction intended to be outside when the rolling assembly 51 being mounted onto a vehicle, thus X′ is a direction intended to be inside when the rolling assembly 51 being mounted onto a vehicle, and comprising a rim 52 having two rim seats 521 being axially outwardly extended by rim flanges 522, one adapter 53 and a tire 54 having two beads 541, the adapter 53 providing the connection between one of the bead 541 and the rim 52.

The adapter 53 comprising an axially inner end 531 that is adapted to be mounted on one of the rim seats 521, an axially outer end 532 that is adapted to receive one of the beads 541 and an adapter body 533 connecting the axially inner end 531 and the axially outer end 532 as to form a single piece.

The two rim seats 521 of the rim 52 having different diameter, smaller diameter Ds and greater diameter Dg with a gap D (indicated as D/2 as FIG. 3 shows half of the rolling assembly 51), the adapter 53 being mounted onto the rim seat 521 having smaller diameter Ds. The rim seat 521 of the rim 52 having smaller diameter Ds positions on a side intended to be inside when the rolling assembly 51 being mounted onto a vehicle.

The gap D is at least equal to 0.25 inches. In this embodiment, this gap D is equal to 0.50 inches.

An axial width of the rim 52 is wider than an axial width of the adapter 53 at inflation state.

Since an axial width of the rim 52 is wider than an axial width of the adapter 53 at inflation state, it is possible to improve further steering of a vehicle by limiting deformable length created by the adapter 53, while still maintaining satisfactory interior noise performance and/or ability to withstand curb impact.

The invention is not limited to the examples described and represented and various modifications can be made there without leaving its framework.

### REFERENCE SIGNS LIST

1, 51 rolling assembly
2, 52 rim
21, 521 rim seat
22, 522 rim flange
3, 53 adapter
31, 531 inner end of adapter
32, 532 outer end of adapter
33, 533 adapter body
4, 54 tire
41, 541 bead

What is claimed is:

1. A rolling assembly having a rotation axis and comprising a rim having two rim seats being axially outwardly extended by rim flanges, one adapter and a tire having two beads, the adapter providing the connection between one of the beads and the rim, the adapter comprising an axially inner end that is adapted to be mounted on one of the rim seats, an axially outer end that is adapted to receive one of the beads and an adapter body connecting the axially inner end and the axially outer end as to form a single piece, the two rim seats of the rim having different diameter with a gap D, the adapter being mounted onto the rim seat having smaller diameter,
wherein the rim seat of the rim has a smaller diameter positions on a side intended to be inside when the rolling assembly is mounted onto a vehicle.

2. The rolling assembly according to claim 1, wherein the gap D is at least equal to 0.25 inches.

3. The rolling assembly according to claim 1, wherein an axial width of the adapter is wider than an axial width of the rim at inflation state.

4. The rolling assembly according to claim 1, wherein an axial width of the rim is wider than an axial width of the adapter at inflation state.
